(19) United States
(12) Patent Application Publication
(10) Pub. No.: US 2019/0345306 A1
(43) Pub. Date: Nov. 14, 2019

(54) RECYCLING PROCESS

(71) Applicant: WORN AGAIN TECHNOLOGIES LIMITED, London (GB)

(72) Inventor: Adam WALKER, London (GB)

(21) Appl. No.: 16/518,309

(22) Filed: Jul. 22, 2019

Related U.S. Application Data
(63) Continuation of application No. 15/328,713, filed on Jan. 24, 2017.

(30) Foreign Application Priority Data
Jul. 24, 2014 (GB) 1413117.1
Jul. 24, 2014 (GB) 1413118.9

(51) Int. Cl. C08J 11/08

(52) U.S. Cl. CPC C08J 11/08; D06P 5/137; Y02W 30/701; Y02P 20/582

(57) ABSTRACT

The invention relates to a process for extracting polyester from packaging. In particular, the invention relates to packaging comprising one or more dyes such as black packaging. The claim process uses a two stage extraction process to convert waste polyester in clean, reusable polyester.

The invention relates to a process for extracting polyester from fabric. In particular, fabric comprising polyester and one or more dyes. The claimed process uses a multistage mechanism to separate dyes from polyester containing garments and reconstitute the polyester.

### FIELD OF INVENTION

The invention relates to a process for extracting polyester from packaging. In particular, food and drink packaging comprising one or more dyes and polyesters. The invention also relates to a process for extracting polyester from fabric. In particular, fabric comprising polyester and one or more dyes.

### BACKGROUND TO THE INVENTION

Plastics are versatile materials that have revolutionised many sectors of industry over the last 50 years. However, the high demand for plastics coupled with the poor biodegradability has led to large amounts of plastic waste which is not easy to dispose of, often ending up in landfill. Although recycling processes have been adopted to convert these waste materials into new production materials, there are still many problems associated with plastics recycling.

In particular, plastics have been used extensively in the packaging sector. Key uses include plastic bags, and food packaging. The vast majority of food and drink today is packaged within plastic bottles and containers, usually containing polyester, and as these materials typically have poor biodegradability, it is desirable for these plastics to be recycled. However, the packaging materials, in addition to plastics like polyester, often also include other additives which can complicate the recycling process. The presence of dyes, used to add colour to packaging, is a particular problem.

Waste packaging often includes a mixture of different plastics containing different dyes. Therefore, in order to recycle these materials, plastics must first be separated based on their colour. However, this sorting process is labour intensive and/or requires the use of optical sorting machines which are expensive. Further, the different coloured plastics are processed separately, requiring multiple recycling processes to be performed in parallel, each process producing recycled plastic of a single colour. Although plastics of different colours can be recycled together, it is usually the case that a stronger dye is added to the plastic in order to mask the combination of different dyes present in the resulting recycled product. This increases the reliance on dyes, limits the uses of the recycled plastics plastic and reduces the number of times the plastic can be recycled. Further still, there is a significant demand in the industry for colourless plastic (i.e. plastics not containing dyes) as this can be coloured to fit a wide range of applications.

Another particular industry where plastics are prevalent is the textile industry. Polyesters are used extensively in many garments and these articles are regularly replaced creating waste that would ideally be recycled. Polyester fabrics often include additives which complicate the recycling process as these must be separated from the polyester. In particular, polyesters are often modified to include dyes to add colour to fabrics. Further, it is frequently the case that many different dyes are used to provide different patterns of colour which makes extracting clean polyesters from these garments difficult.

In view of the difficulty with removing additives from polyester containing garments, recycling processes have been developed which separate garments into different colours and process each particular type of coloured fabric separately. However, this is a very labour intensive process and requires multiple recycling processes to be performed in parallel, each process producing recycled polyester of a single colour. The demand for colourless polyester (i.e. without any dye) is greater than that for dyed plastics as these materials can be coloured as required, and so if possible colour should be removed.

Therefore, what is required is a process for recycling polyester containing packaging comprising on or more dyes to produce clear, reusable plastics. It would also be desirable to have a process for recycling mixtures of dye containing polyester fabrics into usable clear polyester. The invention is intended to solve or at least ameliorate these problems.

### SUMMARY OF THE INVENTION

There is provided in a first aspect of the invention, a process for extracting polyester from packaging containing one or more dyes comprising the steps of: a) contacting the packaging with a first solvent system to form a mixture; b) maintaining the mixture at a first temperature for a first period of time until substantially all of the dye has been dissolved; c) removing the first solvent system containing the dissolved dye; d) contacting the remaining mixture with a second solvent system in order to dissolve the polyester; e) maintaining the remaining mixture at the second temperature for a second period of time until substantially all of the polyester has been dissolved; f) removing the second solvent system containing the dissolved polyester; and g) recovering the polyester from the second solvent system; wherein the first and second solvent systems each essentially consist of one or more food grade solvents; and wherein the second temperature is greater than the first temperature when the first solvent system and the second solvent system are the same.

The polyester that is extracted from packaging is typically selected from: polyglycolic acid (PGA), polylactic acid (PLA), polycaprolactone (PCL), polyethylene adipate (PEA), polyhydroxyalkanoate (PHA), polyethylene terephthalate (PET), polybutylene terephthalate (PBT), polytrimethylene terephthalate (PTT), polyethylene naphthalate (PEN) or combination thereof. More typically, the polyester is polyethylene terephthalate (PET). These polyesters are frequently used in the packaging industry and are often difficult to separate from the dyes they are modified with. As such, this makes them commercially very useful to recycle using the present process.

Although the reaction is typically performed under atmospheric pressure, the process can be performed under higher pressures in order to superheat one or both of the first or second solvent systems. However, this is typically avoided as this usually requires specialised reaction vessels and higher energy conditions which increases the overall cost of the recycling process.

It is often the case that the packaging which is recycled using the claimed process comprises food packaging. The term “food packaging” is intended to cover all trays, bottles, containers, cups, pots, and other vessels for storing solid and liquid foods as well as protective films and covers used to seal such containers. Typically, the packaging comprises black packaging. The term “black packaging” is intended to cover those plastics containing polyesters and a mixture of different dyes wherein at least one of the dyes or an additive masks the appearance of the other dyes. A typical example of this is plastic containers containing carbon black which masks the presence of any dye present leaving the container with a black finish.

Black plastics are a particular problem for the packaging industry as it is often not possible to automate the sorting of black plastics from other coloured plastics (for instance using conventional optical sorting measures) and these black plastics often include more additives and dyes than other dyed plastics.

It is also often the case that the packaging comprises bottles. Plastic bottles often contain polyester and many include several common dyes.

The term “food grade solvents” is intended to refer to compounds which are substantially non-toxic and non-harmful. It is an important requirement where recycled plastics are used to make new packaging materials for the food and drinks industry that no harmful or toxic substances are retained in plastics as a consequence of the recycling process which could leach out into the food or drink contained therein. There is often, albeit at very small concentrations, some residual solvent which remains associated with the recycled polyester. Many countries will not permit the use of recycled polyester or other plastics where the recycling process has involved potentially harmful substances. It is typically the case that “food grade solvents” are those materials considered to be permissible for use in the manufacture of plastics according to legislation such as EU Directive 2002/72/EC.

The inventors have found that the above process allows dyes to be removed from polyester containing packaging without making use of toxic or harmful solvent systems or materials. The first solvent system can be removed using conventional filtration processes leaving the undissolved, dye-free polyester. It is desirable that the polyester does not dissolve in the first solvent system at the first temperature.

The term “dye” or “dyes” is intended to refer to compounds incorporated into materials, polyester containing packaging materials in the present situation, which imbue said materials with a particular colour. In the packaging industry, these dyes are typically organic dyes but some inorganic dyes and salts of organic dyes are also used. However, some colouring agents are very insoluble, typically purely inorganic materials such as titania or carbon black. These substantially insoluble materials can often be removed using simple filtration techniques as they form precipitates. Therefore, reference in the specification to “dyes” is intended to refer to chemical colouring agents, typically organic dyes, which are soluble in organic solvents. Therefore, this term excludes substantially insoluble coloured matter such as titania or carbon black.

Further, the “dyes” referred to herein are considered to be separate from other additives which do not substantially modify the optical properties of the plastics with which they are combined.

The term “dissolve” with reference to dissolution of polyester by the second solvent, means that at least some of the polyester has dissolved. It is typically the case that the second solvent system dissolves at least 50% of the polyester and, even more typically, substantially all of the polyester present in the mixture of steps d) and e). The term “substantially all” is intended to mean greater than 90% of the polyester present in the mixture (for instance 90% to 100%). Typically, the second solvent system dissolves at least 95% of the polyester, more typically at least 99% of the polyester.

The term “solvent system” is intended to mean a homogeneous or heterogeneous combination of one or more solvents. These solvents may or may not be miscible with one another.

The solvent systems used in the invention may be heterogeneous systems comprising two or more immiscible solvents. In this situation, one of the solvents may be selected to dissolve polyester and/or dyes whilst another solvent or solvents may be selected to dissolve common substances found in the packaging being recycled. In use, the heterogeneous systems are typically agitated in order to create a uniform mixture and the packaging is exposed to the mixture. After a period of time, the agitation is halted and the solvent system is allowed to separate and one or more of the immiscible solvent phases can be extracted.

Typically, the solvent systems will be homogeneous as there is no need to adapt the apparatus performing the process to allow removal of separated solvent layers. The solvent systems used in the invention may be homogeneous systems and the solvent systems may comprise one or more compounds as described above or combinations thereof in an amount in the range 30% to 100% by mass of the total mass of the solvent system. This upper limit of 100%, is intended to mean ‘practically 100%’ or ‘99% or 98%’ as, in real world situations, it is never possible to obtain absolute purity. Typically, the solvent system may comprise one or more compounds described above or combinations thereof in an amount of at least 50% by mass of the total mass of the solvent system. Even more typically, the solvent system may comprise one or more compounds described above or combinations thereof in an amount of at least 55%, 60%, 65%, 70%, 75%, 80%, 85%, 90% or 95% by mass of the total mass of the solvent system so, in the range 50%-100%, 55%-100%, 60%-100%, 65%-100%, 70%-100%, 75%-100%, 80%-100%, 85%-100%, 90%-100% or 95%-100% by mass of the total mass of the solvent system.

In a first embodiment of the invention, the first solvent system and the second solvent system are different. This allows each solvent system to be tailored to either one or more of the dyes or to the polyester. Accordingly, by using two solvent systems, each adapted for dissolving a specific component of the packaging, the temperature required to extract each component of the plastic is minimised.

The first solvent system is selected to dissolve the dyes but not the polyester at the first temperature. Further, the first solvent system is typically selected so that dissolution of the dye can occur at a reasonable rate at low temperature. Complete dissolution of the dye would eventually occur if the reaction mixture was maintained at room temperature. However, this typically takes a long time (potentially days) which is often not suitable for commercial recycling. Therefore, it is often the case that the first solvent system is heated to speed up this process. A balance is required between raising the temperature to a level sufficient to dissolve the dye at an acceptable rate without increasing the temperature so much that the polyester becomes soluble in the first solvent system or that the first solvent system is evaporated. Typically, the first temperature is in the range 70° C.-120° C., more typically 80° C.-110° C. or even more typically 90° C.-100° C.

Where the first solvent system and second solvent system are different, it is usually the case that the first solvent system comprises one or more solvents selected from: cycloalkenes; ketones; esters; carbonates; or combinations thereof.

The cycloalkenes used in the first solvent system may comprise limonene and the typical ketones used may comprise cyclopentanone; acetone; or combinations thereof. It is typically the case that the esters used in the first solvent system are alkyl esters, typically selected from: ethyl acetate; propyl acetate; butyl acetate; isobutyl acetate; tert-butyl acetate; amyl acetate; isoamyl acetate; ethyl propionate; ethyl butyrate; ethyl isobutyrate; propyl propionate; propyl butyrate; butyl butyrate; isobutyl butyrate; butyl isobutyrate; isobutyl isobutyrate; ethyl valerate; propyl valerate; butyl valerate; amyl valerate; or combinations thereof.

The term ‘alkyl’ is intended to encompass aliphatic, linear and cyclic saturated carbon chains as well as branched saturated carbon chains. Typically, the alkyl groups used in the invention are in the range C₁ to C₁₀, more typically in the range C₁ to C₈ and even more typically C₁ to C₅. The term ‘aryl’ is intended to refer to an aromatic ring structure. This may include one or more fused rings and the ring or rings may each independently be 5-, 6-, 7-, 8- or 9-membered rings. Typically, the aryl groups will be a single aromatic ring and even more typically, the ring may be a 5-, or 6-membered ring.

The term ‘alkenyl’ is intended to refer to linear or cyclic carbon chains as well as branched carbon chains having at least one unsaturated carbon-carbon double bond. Typically, the alkenyl groups used in the invention are in the range C₁ to C₁₀, more typically in the range C₁ to C₈ and even more typically C₁ to C₅. The term ‘alkynyl’ is intended to refer to linear or cyclic carbon chains as well as branched carbon chains having at least one unsaturated carbon-carbon triple bond. Typically, the alkynyl groups used in the invention are in the range C₁ to C₁₀, more typically in the range C₁ to C₈ and even more typically C₁ to C₅.

The term ‘alkoxy’ is intended to mean an alkyl group as defined above, which is bonded via an oxygen atom.

Where carbonates are used in the first solvent system, the carbonates are typically selected from dimethyl carbonate, diethyl carbonate or combinations thereof. It is often the case that the first solvent system will comprise limonene and/or ethyl acetate. These solvents are relatively inexpensive, have boiling points which makes them useful to extract polyester and be recycled but are also already present in many food stuffs and therefore do not impact negatively if residue is retained in the recycled polyester (albeit in small quantities).

The second solvent system may be heated. This encourages polyester to dissolve in the second solvent system. Usually, the second solvent system is heated to a temperature in the range 50° C. to 150° C., or more typically in the range 60° C. to 130° C., or even more typically in the range 70° C. to 110° C. These temperatures maximise the amount and rate of dissolution of polyester whilst minimising the energy required to raise and sustain the temperature of the solvent system. Once a sufficient quantity of polyester has been dissolved, the solvent system may be separated and can be cooled to precipitate the polyester.

There is no particular restriction on the choice of second solvent system provided that said solvent system is a suitable food grade solvent and dissolves polyester. Preferably, the second solvent system is selected to minimise operating temperatures at which polyester is dissolved and to facilitate extraction of the polyester from said solvent system and recycling of the solvent system. It is typically the case that the second solvent system in this embodiment comprises solvents selected from: arenes; cycloalkanes; aldehydes; ketones; esters; cyclic ethers or combinations thereof.

The arenes are typically substituted benzenes, typically alkyl or alkoxy benzenes. Examples of alkyl benzenes include p-cymene and typical examples of alkoxy benzenes include dimethoxybenzene, anethole, vanillyl butyl ether and methoxyphenyl butanone.

It is often the case that the aldehydes used as the second solvent system comprise a solvent selected from: benzaldehyde; anisaldehyde; phenylacetaldehyde; cinnamaldehyde; phenyl butenal; or combinations thereof.

Where ketones are used in the second solvent system, these are typically selected from: menthone; fenchone; carvone; acetophenone; methoxyacetophenone; propiophenone; butyrophenone; or combinations thereof. The esters used in the second solvent system often comprise alkyl benzoates such as: methyl benzoate; ethyl benzoate; propyl benzoate; isopropyl benzoate; butyl benzoate; isobutyl benzoate; sec-butyl benzoate; tert-butyl benzoate; hexyl benzoate. The esters may also be selected from: amyl benzoate; isoamyl benzoate; acetyl tributyl citrate; menthyl acetate; fenchyl acetate; bornyl acetate; gamma-butyrolactone; gamma-valerolactone; gamma-caprolactone; alpha-angelicalactone; phenyl acetate; benzyl acetate; benzyl propionate; benzyl butyrate; benzyl isobutyrate; benzyl 2-methylbutyrate; benzyl valerate; benzyl benzoate; methyl phenylacetate; methyl cinnamate; ethyl cinnamate; propyl cinnamate; cinnamyl acetate; cinnamyl propionate; phenyl benzoate; anisyl acetate; 2-phenethyl 2-methylbutyrate; methyl salicylate; ethyl salicylate; methyl anisate; ethyl anisate; or combinations thereof. A typical cyclic ether which may be used in the second solvent system is cineole.

The second solvent system may also make use of supercritical CO₂ as a solvent.

It is often the case that the second solvent system comprises a low chain aromatic alkyl ester, cinnamate ester or combinations thereof. In particular, methyl and/or ethyl benzoate are often used in the second solvent system. The inventors have found that these solvents are not only excellent solvents for polyester, but also are common ingredients in foods and therefore do not pose a risk to end users of packaging containing trace quantities of these compounds.

In a second embodiment of the invention, the first solvent system and the second solvent system are the same. In this situation the second temperature is greater than the first temperature. The solvent system is selected so that, at the first temperature, the solvent system dissolves dyes but does not substantially dissolve polyester and at the second temperature, which is typically higher than the first temperature, the solvent system dissolves polyester. This allows one solvent to be used to remove dyes and dissolve the polyester. This simplifies the polyester extraction process.

It is typically the case that the first and second solvent systems in this embodiment comprise solvents selected from: arenes; cycloalkanes; aldehydes; ketones; esters; cyclic ethers or combinations thereof.

The arenes are typically substituted benzenes, typically alkyl or alkoxy benzenes. Examples of alkyl benzenes include p-cymene and typical examples of alkoxy benzenes include dimethoxybenzene, anethole, vanillyl butyl ether and methoxyphenyl butanone.

It is often the case that the aldehydes used as the second solvent system comprise a solvent selected from: benzaldehyde; anisaldehyde; phenylacetaldehyde; cinnamaldehyde; phenyl butenal; or combinations thereof.

Where ketones are used in the first and second solvent systems, these are typically selected from: menthone; fenchone; carvone; acetophenone; methoxyacetophenone; propiophenone; butyrophenone; or combinations thereof. The esters which may be used in the second solvent system are typically selected from: acetyl tributyl citrate; menthyl acetate; fenchyl acetate; bornyl acetate; gamma-butyrolactone; gamma-valerolactone; gamma-caprolactone; alpha-angelicalactone; alkyl benzoate; methyl benzoate; ethyl benzoate; propyl benzoate; isopropyl benzoate; butyl benzoate; isobutyl benzoate; sec-butyl benzoate; tert-butyl benzoate; amyl benzoate; isoamyl benzoate; hexyl benzoate; benzyl acetate; benzyl propionate; benzyl butyrate; benzyl isobutyrate; benzyl 2-methylbutyrate; benzyl valerate; benzyl benzoate; methyl phenylacetate; methyl cinnamate; ethyl cinnamate; propyl cinnamate; cinnamyl acetate; cinnamyl propionate; phenyl benzoate; anisyl acetate; 2-phenethyl 2-methylbutyrate; methyl salicylate; ethyl salicylate; methyl anisate; ethyl anisate; or combinations thereof. Typical cyclic ethers include cineole.

Another solvent system which may be used as the first and second solvent systems is supercritical CO₂.

It is often the case that the first and second solvent systems comprise a low chain aromatic alkyl ester or cinnamate ester or combination thereof. In particular, methyl and/or ethyl benzoate are often used in the second solvent system. These solvents have been found by the inventors to show excellent versatility in dissolving both dyes and polyester at different temperatures.

It is usually the case that the first temperature is in the range 70° C.-120° C., more typically 80° C.-110° C. or even more typically 90° C.-100° C. The second temperature is typically 100° C.-200° C., more typically 110° C.-180° C. and even more typically 120° C.-150° C.

Whilst there is no particular restriction on the period of time that a packaging is exposed to the solvent systems of the invention, this period may be in the range 30 minutes to 4 hours, more typically in the range 45 minutes to 3 hours, or even more typically in the range 1 to 2 hours. These durations minimise the amount of time required to dissolve a sufficient proportion of the dyes or polyester against the energy required to sustain the temperature of the solvent systems for said period of time.

The process is usually conducted at atmospheric pressure. The process can be conducted under pressurised conditions, in order to achieve a superheated solvent system with higher temperatures than those available at standard pressure and therefore faster rates of reaction. However, this often requires specific reaction chambers capable of withstanding high pressure and intensive heating. This requires a greater input of energy and does not usually improve the energy efficiency of the process.

Not all colouring agents are readily soluble. For example, carbon black is sometimes used to provide a black colour to packaging which consists essentially of non-diamond carbon. This and other inorganic materials are insoluble in most solvent systems. Accordingly, the process may include a filtration step wherein the dissolved polyester is filtered to remove fine particles of inorganic and other insoluble matter.

Once the polyester has been dissolved it is typically extracted from the second solvent system by evaporating the solvent. This can be done using elevated temperatures and/or using vacuum extraction to remove the solvent to leave the dye-free polyester. It is often the case that the removed second solvent system is condensed and reused in the process. The removed second solvent system may be used either as a source of the first solvent system in step a) and/or as a source of the second solvent system which is used in step d). Typically, and necessarily where the first solvent system is not the same as the second solvent system, the second solvent system is reused as the second solvent system in step d). This reduces the amount of waste solvent generated in the process and minimises the amount of solvent required for the reaction.

The first solvent system is also typically isolated from the dyes using elevated temperatures and/or vacuum extraction to remove the first solvent system. This can be condensed and reused in the process to further minimise the amount of waste solvent generated by the process. This also isolates the dye materials originally present in the packaging which can themselves be reused, for instance in the manufacture of new clothes.

The first solvent system is often recycled and reused as the first solvent system in step a) and/or as the second solvent system used in step d) where the first and second solvent systems are the same. Typically, the first solvent system is reused as the first solvent system in step a). This recycling of reagents reduces the reliance of the process on new feed of solvent and reduces the amount of solvent consumed.

There is provided in a second aspect of the invention, a process for extracting polyester from fabric containing one or more dyes comprising the steps of: a) contacting the fabric with a first solvent system to form a mixture; b) maintaining the mixture at a first temperature for a first period of time until substantially all of the dye has been dissolved; c) removing the first solvent system containing the dissolved dye; d) contacting the remaining mixture with a second solvent system in order to dissolve the polyester; e) maintaining the remaining mixture at the second temperature for a second period of time until substantially all of the polyester has been dissolved; f) removing the second solvent system containing the dissolved polyester; and g) recovering the polyester from the second solvent system; wherein the second temperature is greater than the first temperature when the first solvent system and second solvent system are the same; and wherein the first and/or second solvent systems are selected from: amides; esters; arenes; heteroarenes; haloalkanes; haloalkenes; cycloalkanes; cyclic ethers; aldehydes; ketones; carbonates; sulfoxides; nitriles; phosphorus containing compounds; ionic liquids or combinations thereof.

The term “solvent system” carries the same meaning provided in the first aspect of the invention.

The term “fabric” is intended to mean any material comprising a matrix of woven and/or non-woven fibres. A “polyester fabric” is intended to mean a fabric in which at least one of the fibres contains polyester. Fabrics are included in a range of consumer products, such as furniture, clothing and offcuts created during the clothing manufacturing process, and a great deal of fabric is frequently discarded along with the associated product. As such, the invention allows polyester to be readily extracted from these fabrics in a cost effective manner which would otherwise simply be disposed of akin to conventional waste.

It is often the case that the fabric is clothing. The term “clothing” is intended to encompass all forms of apparel. Most clothing is used regularly and is washed frequently. This typically causes clothing to become damaged and no longer useable more quickly than other products containing fabric. In view of the low cost to manufacture polyester clothing, the expense of conventional recycling techniques and high demand for new clothing (for example from the fashion industry), the established practise in the art is to simply dispose of waste clothing with conventional rubbish although energetic recycling techniques have been used.

The term “dye” or “dyes” carries the same meaning provided in the first aspect of the invention.

The terms “alkyl”, “alkenyl” and “alkoxy” carry the same meanings as described above.

As with the first aspect of the invention, although the reaction is typically performed under atmospheric pressure, the process can be performed under higher pressures in order to superheat one or both of the first or second solvent systems. However, this is typically avoided as this usually requires specialised reaction vessels and higher energy conditions which increases the overall cost of the recycling process.

In a one embodiment of the invention the first solvent system and the second solvent are different. This allows each solvent system to be tailored to either one or more of the dyes and to the polyester respectively. Accordingly, by using two solvent systems, each adapted for dissolving a specific component of the fabrics, the temperature required to extract dye-free polyester can be minimised.

The first solvent system is selected to dissolve the dyes but not the polyester at the first temperature. Further, the first solvent system is typically selected so that dissolution of the dye can occur at a reasonable rate at low temperature. Complete dissolution of the dye would eventually occur if the reaction mixture was maintained at room temperature. However, this typically takes a long time (potentially days) which is often not suitable for commercial recycling. Therefore, it is often the case that the first solvent system is heated to speed up this process. A balance is required between raising the temperature to a level sufficient to dissolve the dye at an acceptable rate without increasing the temperature so much that the polyester becomes soluble in the first solvent system or that the first solvent system is evaporated. Typically, the first temperature is in the range 70° C.-120° C., more typically 80° C.-110° C. or even more typically 90° C.-100° C.

In one example, the second solvent system may be heated. This encourages polyester to dissolve in the second solvent system. Usually, the second solvent system is heated to a temperature in the range 50° C. to 150° C., or more typically in the range 60° C. to 130° C., or even more typically in the range 70° C. to 110° C. These temperatures maximise the amount and rate of dissolution of polyester whilst minimising the energy required to raise and sustain the temperature of the solvent system. Once a sufficient quantity of polyester has been dissolved, the solvent system may be separated and can be cooled and extracted to precipitate the polyester.

It is usually the case that the first solvent system comprises one or more solvents selected from: ketones, haloalkanes, haloalkenes, arenes, substituted cycloalkanes, esters, carbonates or combinations thereof. Typically, the first solvent system comprises ketones.

The ketones used in the present invention may be linear or cyclic ketones. Typical ketones that are used in the invention are selected from: menthone; fenchone; carvone; acetophenone; methoxyacetophenone; propiophenone; butyrophenone; cyclohexyl methyl ketone; cyclopentylcyclopentanone; thujone; valerophenone; henylacetone; benzophenone; acetonaphthone; acetyltetralin; dibenzoylbenzene; alpha-tetralone; bicyclopentanone; bicyclohexanone; or combinations thereof.

Usually, the first solvent system comprises cyclic ketones. Typical examples of cyclic ketones include: pivalone; cyclopentyl methyl ketone; cyclohexanone; cycloheptanone; cyclopentanone; or combinations thereof. These compounds are relatively inexpensive and have boiling points which allow them to be easily separated from dye mixtures without requiring excessively high temperatures.

In particular, the cyclic ketones used in the first solvent may comprise cyclohexanone. Cyclohexanone has a high boiling point, is relatively inexpensive and is useful in dissolving many common organic dyes found in fabrics.

The haloalkanes and haloalkenes are typically selected from chloro and/or bromo alkanes and alkenes. It is often the case that the haloalkanes and haloalkenes are selected from: dichloromethane; chloroform; dichloroethane; trichloroethane; tetrachloroethane; dichloroethene; dibromomethane; bromopropane; dibromopropane; or combinations thereof.

The arenes are typically substituted arenes and more typically include alkyl arenes, amino-substituted arenes and substituted heterocyclic arenes. The alkyl arenes are typically selected from: benzene; toluene; xylene; ethylbenzene. Typical amino substituted benzenes include: aniline; N,N-dimethylaniline; N,N-diethylaniline; pyridine; or combinations thereof.

Usually, the substituted cycloalkanes are substituted heterocycloalkanes. Examples of typical substituted heterocycloalkanes include: tetrahydrofuran; tetrahydrosilvan; tetrahydropyran; dimethoxyethane; dioxolane; anisole; morpholine; or combinations thereof. Cycloalkenes may also be used such as limonene.

Esters used in the invention are typically alkyl esters. The alkyl esters are typically selected from: ethyl acetate; propyl acetate; butyl acetate; isobutyl acetate; tert-butyl acetate; amyl acetate; isoamyl acetate; ethyl propionate; ethyl butyrate; ethyl isobutyrate; propyl propionate; propyl butyrate; butyl butyrate; isobutyl butyrate; butyl isobutyrate; isobutyl isobutyrate; ethyl valerate; propyl valerate; butyl valerate; amyl valerate; or combinations thereof.

Where carbonates are used in the first solvent system, it is typically the case that the carbonates are selected from: dimethyl carbonate; diethyl carbonate; or combinations thereof.

It is often the case that the second solvent system comprises: amides; heteroarenes; cyclic ethers; aldehydes; ketones; esters; arenes; sulfoxides; nitriles; imidazolium compounds; phosphates; or combinations thereof.

Typically, the second solvent system comprises amides. This includes linear and cyclic amides. Typically, linear amides are selected from: dimethylformamide; diethylformamide; ethylmethylformamide; dipropylformamide; dibutylformamide; dimethylacetamide; diethylacetamide; dimethylpropionamide; dimethylbutyramide; or combinations thereof.

It is often the case that cyclic amides are used and typical examples of cyclic amides are selected from compounds according to any of general Formula I

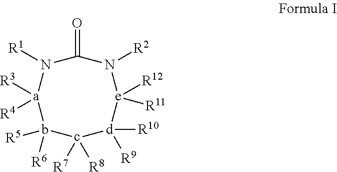

wherein R¹ and R² are each independently selected from: hydrogen, alkyl, alkenyl, alkynyl, aryl or alkoxy groups; R³ to R¹² are each independently selected from: hydrogen, alkyl, alkenyl, alkynyl, aryl or alkoxy groups; wherein each of a to e is a carbon atom, wherein the total linear chain length of a-b-c-d-e is in the range 2 to 5 carbons.

The total linear chain length of a-b-c-d-e is often in the range 2 to 4 carbons. Typically, the total linear chain length of a-b-c-d-e is in the range 2 to 3 carbons, and more typically the total linear chain length of a-b-c-d-e is 2 carbons. So, for instance, in a five membered ring, a and b could arbitrarily be present, and c, d and e arbitrarily absent. Each of a to e are equivalent in terms of possible substituents, and the identifiers a to e and R³ to R¹² allow for the independent substitution of each ring carbon with each of the options for substituent as defined above. Accordingly, the total ring size may be five membered (2 carbons, for instance a and b present and c, d and e absent), six membered (3 carbons, for instance a-c present and d and e absent), seven membered (4 carbons, for instance a-d present and e absent) or eight membered (all of a-e present). However, often the ring will be five or six membered, often five membered.

R³ to R¹² may be alkyl, particularly short chain alkyl such as methyl, ethyl or n-propyl. Often, each carbon will carry only one substituent, so that on each carbon one of the R groups will be H. For instance, R³ may be hydrogen and R⁴ selected from alkyl, alkenyl, alkynyl, aryl and alkoxy groups. Similar patterns may be found for b with R⁵ and R⁶, c with R⁷ and R⁸, d with R⁹ and R¹⁰, and e with R¹¹ and R¹².

Often one or more of a-e will have the associated R groups as H, so that not all ring carbon atoms are substituted. For instance, R³ and/or R⁴ may be selected from alkyl, alkenyl, alkynyl, aryl and alkoxy but the others of R⁵-R¹² may be H. Having only one substituent (R H) on some or all carbon atoms and/or having substituents on some carbon atoms only, ensures that solubility is retained.

Typically, the cyclic amides comprise: N-methyl-2-pyrrolidinone; N-ethyl-2-pyrrolidinone; N-acetyl-2-pyrrolidinone; delta-valerolactam; epsilon-caprolactam; N-methyl-epsilon-caprolactam; N-acetyl-epsilon-caprolactam; N-phenyl-2-pyrrolidinone; N-benzyl-2-pyrrolidinone; 1,3-dimethyltetrahydro-2-pyrimidone; 1,3-diethyltetrahydro-2-pyrimidone; 1,3-dimethyl-2-imidazolidinone; 1,3-diethyl-2-imidazolidinone; or combinations thereof.

It is often the case that the second solvent system comprises 1,3-dimethyl-2-imidazolidinone (DMI). The inventors have found that DMI is an especially effective solvent for not only dissolving polyester but also for leaching dyes from polyester fabrics.

Typically, the arenes are substituted arenes, such as alkyl arenes, alkoxy arenes, haloalkyl arenes, nitroarenes or combinations thereof. Typical alkyl arenes are selected from: p-cymene; diethylbenzene; trimethylbenzene; mesitylene; durene; cumene; propylbenzene; butylbenzene; isobutylbenzene; tert-butylbenzene; butyltoluene; amylbenzene; hexylbenzene; tetrahydronaphthalene; 1-methylnaphthalene; diphenylmethane; or combinations thereof.

Typically alkoxy arenes are selected from: dimethoxybenzene; veratrole; anethole; phenetole; vanillyl butyl ether; 4-(p-methoxyphenyl)-2-butanone; hydroquinone diethyl ether; propyl phenyl ether; butyl phenyl ether; benzyl methyl ether; benzyl ethyl ether; benzyl propyl ether; benzyl butyl ether; diphenyl ether; dibenzyl ether; eugenol methyl ether; isoeugenol methyl ether; methylchavicol; or combinations thereof.

It is often the case that the haloalkyl arenes are selected from: chloroanisole; bromoanisole; diphenylchloromethane; 1-chloro-2-phenylethane; benzyl bromide; chlorobenzene; dichlorobenzene; chlorotoluene; bromobenzene; iodobenzene; benzyl chloride; or combinations thereof.

Where nitroarenes are used, it is typically the case that the nitroarene is nitrobenzene.

The heteroarenes used in the invention typically comprise one or more substitutions of a carbon atom with a nitrogen or oxygen atom. Typically only a single substitution is present and also most commonly nitrogen is the substituting element. Typical heteroarenes are selected from: N-acetylmorpholine; N-propionylmorpholine; N-methylformanilide; N-ethylformanilide; N-acetylhomopiperazine; acetylpyridine; N,N′-diacetylpiperazine; or combinations thereof.

The cyclic ethers may be selected from: cineole; alpha-pinene oxide; or combinations thereof. Where aldehydes are used, these may be selected from: benzaldehyde; anisaldehyde; 2-phenylacetaldehyde; cinnamaldehyde; 2-phenyl-2-butenal; or combinations thereof.

Esters used in the present invention may include: acetyl tributyl citrate; menthyl acetate; fenchyl acetate; bornyl acetate; gamma-butyrolactone; gamma-valerolactone; gamma-caprolactone; alpha-angelicalactone; alkyl benzoate; methyl benzoate; ethyl benzoate; propyl benzoate; isopropyl benzoate; butyl benzoate; isobutyl benzoate; sec-butyl benzoate; tert-butyl benzoate; amyl benzoate; isoamyl benzoate; hexyl benzoate; benzyl acetate; benzyl propionate; benzyl butyrate; benzyl isobutyrate; benzyl 2-methylbutyrate; benzyl valerate; benzyl benzoate; methyl phenylacetate; methyl cinnamate; ethyl cinnamate; propyl cinnamate; cinnamyl acetate; cinnamyl propionate; phenyl benzoate; anisyl acetate; 2-phenethyl 2-methylbutyrate; methyl salicylate; ethyl salicylate; methyl o-anisate; methyl m-anisate; methyl p-anisate; ethyl anisate; ethylene glycol phenyl ether acetate; ethylene glycol 2-phenethyl ether acetate; propylene glycol phenyl ether acetate; propylene glycol benzyl ether acetate; diethylene glycol methyl ether benzoate; diethylene glycol benzyl ether acetate; dipropylene glycol methyl ether acetate; dipropylene glycol ethyl ether acetate; dipropylene glycol propyl ether acetate; dipropylene glycol butyl ether acetate; dipropylene glycol phenyl ether acetate; dipropylene glycol benzyl ether acetate; cyclohexyl benzoate; dimethyl phthalate; diethyl phthalate; dipropyl phthalate; dibutyl phthalate; diamyl phthalate; methyl ethyl phthalate; methyl ethyl phthalate; methyl propyl phthalate; methyl butyl phthalate; dimethyl isophthalate; diethyl isophthalate; dimethyl terephthalate; diethyl terephthalate; dipropyl terephthalate; dibutyl terephthalate; diisopropyl terephthalate; diisobutyl terephthalate; diethylene glycol dibenzoate; dipropylene glycol dibenzoate; trimethyl orthobenzoate; triethyl orthobenzoate; or combinations thereof.

Most typically, the esters comprise compounds according to general formulae IV and V:

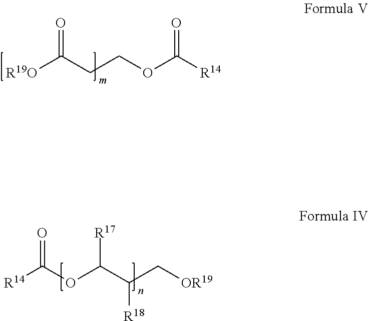

wherein R¹⁴ is an aryl group and wherein R¹⁷ to R¹⁹ are each independently selected from hydrogen, alkyl, alkenyl, alkynyl or aryl groups; n is an integer in the range 1 to 8 and m is 3.

The sulfoxides used in the invention may be selected from: dimethylsulfoxide; methyl ethyl sulfoxide; diethylsulfoxide; dipropylsulfoxide; dibutylsulfoxide; diisopropylsulfoxide; diisobutylsulfoxide; tetramethylenesulfoxide; or combinations thereof. Other sulfur containing compounds, other than sulfoxides, that may be employed include: Tetramethylene sulfide; methylsufate; or combinations therof.

The nitrile compounds may be selected from: benzonitrile; phenylacetonitrile; cinnamonitrile; or combinations thereof.

Furthermore, the second solvent system may include a phosphorus containing compound selected from: triethyl phosphite; triethyl phosphate; tripropyl phosphate; tributyl phosphate; dimethylphosphate; hexamethylphosphoramide; or combinations thereof.

In addition, supercritical carbon dioxide can also serve as a useful second solvent system. The second solvent system may also comprise an ionic liquid. Typically the ionic liquids comprise a compound according to general formula VI

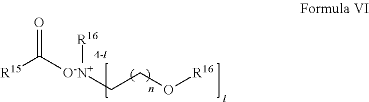

wherein R¹⁵ is an aryl groups and R¹⁶ is selected from hydrogen, alkyl, alkenyl, alkynyl or aryl groups; and 1 is an integer in the range 1 to 3. The ionic liquid may comprise imidazolium cations selected from: 1,3-dimethylimidazolium; 1-ethyl-3-methylimidazolium; 1-butyl-3-methylimidazolium; or combinations thereof. Typical counter ions used with these ionic liquids include acetate and benzoate. Other examples of ionic liquids include tris(2-(2-methoxyethoxy)ethyl)ammonium benzoate.

The inventors have found that the above mentioned first and second solvent systems are particular effective at dissolving dyes and polyesters respectively. Without being bound by theory, it is believed that the first solvent system at the first temperature promotes swelling of the polyester which encourages the leaching of dye from the polyester into the first solvent system. The first solvent system can then be removed using conventional filtration processes leaving the undissolved, dye-free polyester. It is desirable that the polyester does not dissolve in the first solvent system at the first temperature.

In a further embodiment of the invention, the first solvent system and the second solvent system are the same. In this situation the second temperature is greater than the first temperature. The solvent system is selected so that, at the first temperature, the solvent system dissolves dyes but does not substantially dissolve polyester and at the second temperature, which is higher than the first temperature, the solvent system dissolves polyester. This allows one solvent system to be used to remove dyes and dissolve the polyester. This simplifies the polyester extraction process.

It is usually the case that the first temperature is in the range 70° C.-120° C., more typically 80° C.-110° C. or even more typically 90° C.-100° C. The second temperature is typically 100° C.-200° C., more typically 110° C.-180° C. and even more typically 120° C.-150° C.

In this embodiment, it is often the case that the first and second solvent systems both comprise solvent systems as described above.

It is typically the case that the second solvent system at the second temperature dissolves substantially all of the polyester present in the mixture of steps d) and e). The term “substantially all” is intended to mean greater than 90% of the polyester present in the mixture (for instance 90%-100%). Typically, the second solvent dissolves at least 95% of the polyester, more typically at least 99% of the polyester.

The polyester that is extracted from fabrics is typically selected from: polyglycolic acid (PGA), polylactic acid (PLA), polycaprolactone (PCL), polyethylene adipate (PEA), polyhydroxyalkanoate (PHA), Polyethylene terephthalate (PET), polybutylene terephthalate (PBT), polytrimethylene terephthalate (PTT), polyethylene naphthalate (PEN) or combination thereof. More typically, the polyester is polyethylene terephthalate (PET). These polyesters are frequently used in the textile industry and are often difficult to separate from the dyes they are modified with. As such, this makes them commercially very useful to recycle using the present process.

The solvent systems used in the invention may be heterogeneous systems or homogeneous systems as described above. Whilst there is no particular restriction on the period of time that a garment is exposed to the solvent systems of the invention, this period may be in the range 30 minutes to 4 hours, more typically in the range 45 minutes to 3 hours, or even more typically in the range 1 to 2 hours. These durations minimise the amount of time required to dissolve a sufficient proportion of the dyes or polyester against the energy required to sustain the temperature of the solvent systems for said period of time.

The process is usually conducted at atmospheric pressure. The process can be conducted under pressurised conditions, in order to achieve superheated a solvent system with higher temperatures than those available at standard pressure and therefore faster rates of reaction. However, this often requires specific reaction chambers capable of withstanding high pressure and intensive heating. This requires a greater input of energy and does not usually improve the energy efficiency of the process.

Not all colouring agents are readily soluble. For example, carbon black is sometimes used to provide a black colour to garments which consists essentially of non-diamond carbon. This and other inorganic materials are insoluble in most solvent systems. Further, many garments containing a blend of polyester and other materials (such as cotton) which do not dissolve in the second solvent system. Accordingly, the process may include a filtration step wherein the dissolved polyester is filtered to remove fine particles of inorganic and other insoluble matter.

Once the polyester has been dissolved it is typically extracted from the second solvent system by evaporating the solvent. This can be done using elevated temperatures and/or using vacuum extraction to remove the solvent to leave the dye-free polyester. It is often the case that the removed second solvent system is condensed and reused in the process. The removed second solvent system may be used either as a source of the first solvent system in step a) and/or as a source of the second solvent system which is used in step d). Typically, and necessarily where the first solvent system is not the same as the second solvent system, the second solvent is reused as the second solvent system in step d). This reduces the amount of waste solvent generated in the process and minimises the amount of solvent required for the reaction.

The first solvent system is also typically isolated from the dyes using elevated temperatures and/or vacuum extraction to remove the first solvent system. This can be condensed and reused in the process to further minimise the amount of waste solvent generated by the process. This also isolates the dye materials originally present in the garments which can themselves be reused, for instance in the manufacture of new clothes.

The first solvent system is often recycled and reused as the first solvent system in step a) and/or as the second solvent system used in step d) where the first and second solvent systems are the same. Typically, the first solvent system is reused as the first solvent system in step a). This recycling of reagents reduces the reliance of the process on new solvent and reduces the amount of solvent consumed.

The process for extracting dye from the polyester articles may be done as a batch process or a continuous process. Typically however, the process is a continuous process. For example, where the first and second solvents used in the invention are the same, a continuous stream of solvent may be passed through a column of dyed polyester. Solvent solution may be based through the column until no further dye is leeched from the polyester. The temperature of the column could then, for example, be increased in order to dissolve the remaining “clear” polyester. Alternatively, a second solvent could be added to better dissolve the “clear” polyester. Examples of continuous process include a Soxhlet extraction process.

The polyester to be treated using the process of the invention may first undergo a size reducing step. There is no particular limitation as to how the size reduction step is performed. For example, the polyester to be treated may be shredded into flakes. This increases the surface area of the polyester articles to be treated and therefore speeds up the dissolution process.

The invention will now be described with reference to the following figures, drawings and examples.

### BRIEF DESCRIPTION OF THE DRAWINGS

FIGS. 1 and 2 show schematic diagrams of a typical embodiment of the process of the invention wherein the first solvent system and the second solvent system are the same.

FIGS. 3 and 4 show schematic diagrams of a typical embodiment of the process of the invention wherein the first solvent system and the second solvent system are different.

### DESCRIPTION

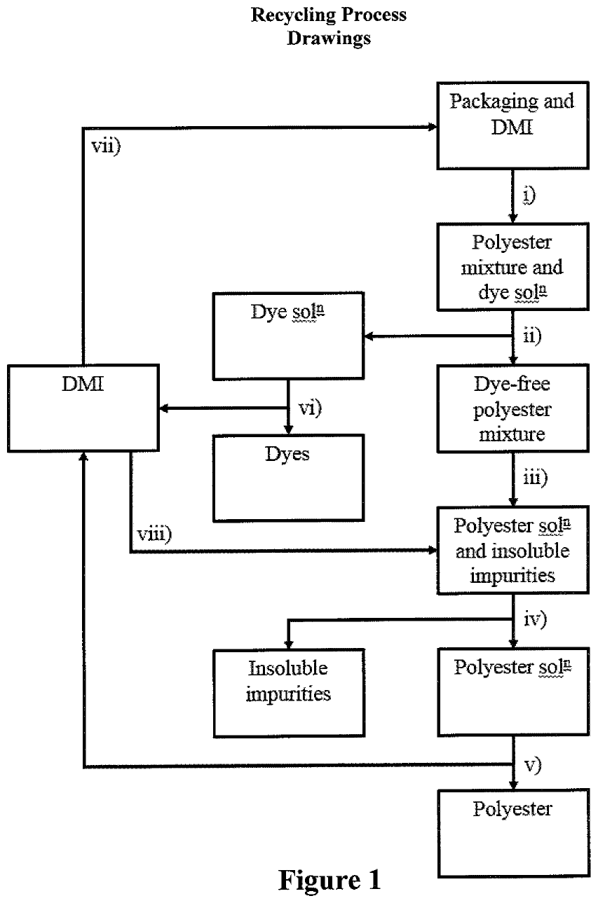

FIG. 1 shows an example of the recycling process of the invention, wherein the solvent used for both the dye extraction step and polyester extraction steps is methyl benzoate. Packaging containing polyesters are comminuted and mixed with an excess of methyl benzoate and the reaction mixture is heated to a temperature in the range 90° C. to 100° C. for approximately 10 minutes in step i). The reaction material is then filtered and the dye containing methyl benzoate solution is isolated from the polyester mixture in step ii). The dye solution is evaporated under vacuum to separate the methyl benzoate solvent from the dissolved dyes in step vi). The extracted methyl benzoate is then available for recycling into the initial reaction vessel in step vii) or can be incorporated into the reaction mixture in step viii).

The polyester mixture is then reacted with methyl benzoate at a temperature of 120° C. to 130° C. for two hours until all at least 95% of the polyester has been dissolved in step iii). The resulting mixture is then filtered in step iv) to separate the methyl benzoate/polyester mixture from the remaining insoluble impurities. The polyester is the isolated by evaporating the methyl benzoate under vacuum in step v). The evaporated methyl benzoate is condensed and can then be reintroduced into the reaction mixture at step vii) or alternatively can be introduced into the reaction mixture at step viii).

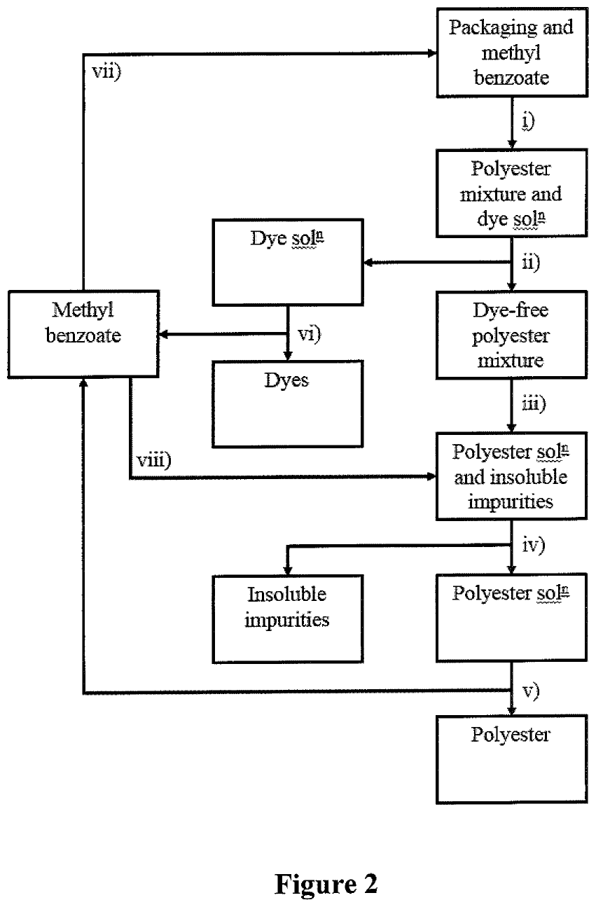

FIG. 2 shows an example of the recycling process of the invention, wherein the solvent used for both the dye extraction step and polyester extraction steps is 1,3-dimethylimidazolidinone (hereafter referred to as “DMI”). Packaging containing polyesters are comminuted and mixed with an excess of DMI and the reaction mixture is heated to a temperature in the range 90° C. to 100° C. for approximately 10 minutes in step i). The reaction material is then filtered and the dye containing DMI solution is isolated from the polyester mixture in step ii). The dye solution is evaporated under vacuum to separate the DMI solvent from the dissolved dyes in step vi). The extracted DMI is then available for recycling into the initial reaction vessel in step vii) or can be incorporated into the reaction mixture in step viii).

The polyester mixture is then reacted with DMI at a temperature in the range 120° C. to 130° C. for two hours until all at least 95% of the polyester has been dissolved in step iii). The resulting mixture is then filtered in step iv) to separate the DMI/polyester mixture from the remaining insoluble impurities. The polyester is then isolated by evaporating the DMI under vacuum in step v). The evaporated DMI is condensed and can then be reintroduced into the process in step vii) or alternatively can be introduced into the reaction mixture in step viii).

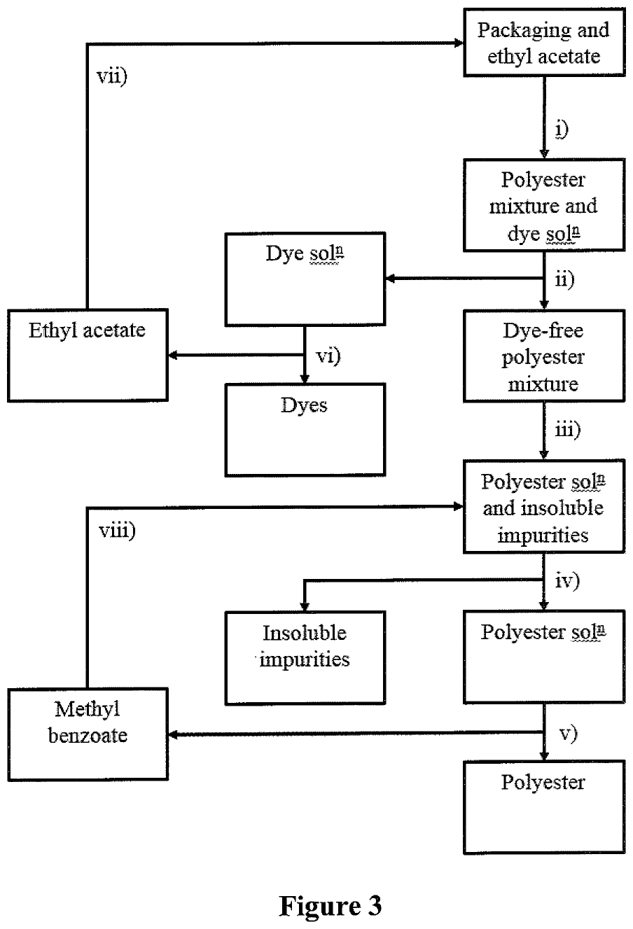

FIG. 3 shows an example of the recycling process of the invention wherein the solvent used to extract the dyes is different to the solvent used to extract the polyester from the packaging. Packaging containing polyester are comminuted and mixed with an excess of ethyl acetate and the reaction mixture is heat to a temperature in the range 90° C. to 100° C. for approximately 10 minutes in step i). The reaction material is then filtered and the dye containing ethyl acetate solution is isolated from the polyester mixture in step ii). The dye solution is evaporated under vacuum to separate the ethyl acetate solvent from the dissolved dyes in step vi). The extracted ethyl acetate is then available for recycling into the initial reaction vessel in step vii).

The polyester mixture is then treated with methyl benzoate at a temperature of 120° C. to 130° C. for two hours until all at least 95% of the polyester has been dissolved in step iii). The resulting mixture is then filtered in step iv) to separate the methyl benzoate/polyester mixture from the remaining insoluble impurities. The polyester is the isolated by evaporating the methyl benzoate under vacuum in step v). The evaporated methyl benzoate is condensed and can then be reintroduced into the reaction mixture in step viii).

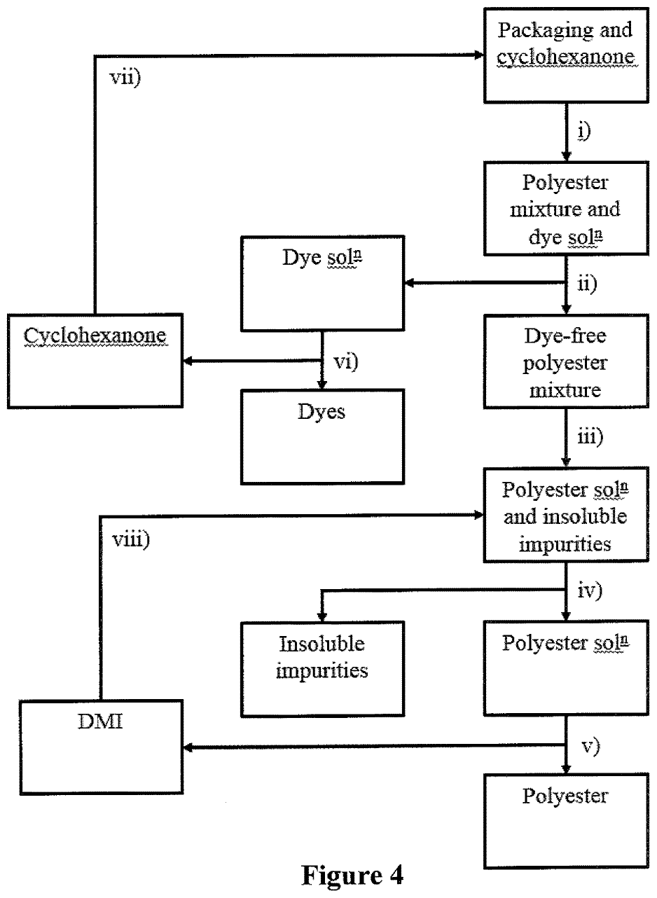

FIG. 4 shows an example of the recycling process of the invention wherein the solvent used to extract the dyes is different to the solvent used to extract the polyester from the garments. Garments containing polyester are comminuted and mixed with an excess of cyclohexanone and the reaction mixture is heated to a temperature in the range 90° C. to 100° C. for approximately 10 minutes in step i). The reaction material is then filtered and the dye containing cyclohexanone solution is isolated from the polyester mixture in step ii). The dye solution is evaporated under vacuum to separate the cyclohexanone solvent from the dissolved dyes in step vi). The extracted cyclohexanone is then available for recycling into the initial reaction vessel in step vii).

The polyester mixture is then reacted with 1,3-Dimethyl-2-imidazolidinone (DMI) at a temperature of 120° C. to 130° C. for two hours until all at least 95% of the polyester has been dissolved in step iii). The resulting mixture is then filtered in step iv) to separate the DMI/polyester mixture from the remaining insoluble impurities. The polyester is the isolated by evaporating the DMI under vacuum in step v). The evaporated DMI is condensed and can then be reintroduced into the reaction mixture in step viii).

### EXAMPLES

### Example 1

### Dissolution of Bottle Grade poly(ethylene terephthalate) (PET) in ethyl benzoate

Ethyl benzoate (>99%, Sigma Aldrich, 250 mL) was placed in a 1 litre round bottomed flask equipped with reflux condenser and magnetic stirrer and heated to 120° C. with stirring on a hot plate. Mixed post-consumer PET chip from plastic bottles (10 g, mixture of colourless, blue and green) was added to the solvent and the mixture was stirred for 30 minutes at 120° C. Over this period, the solvent was observed to turn green in colour owing to the leaching of dyestuffs. The PET was heavily permeated and swollen by the solvent but did not dissolve to a significant extent. The mixture was then heated to in the range 180-200° C. for a further 2 hours, with stirring, over which period the solid PET was observed to entirely dissolve, yielding a clear green solution. Heating was discontinued and the solution was allowed to cool to room temperature, whereupon it solidified into a waxy polymer-solvent gel phase of a pale blue-green colour. This material was transferred to a filter funnel and washed with a further 250 mL cold ethyl benzoate. The solid was then triturated with a large excess of cold 50% ethanol to remove solvent and dyestuffs. This yielded a pale greenish filtrate and a damp white semicrystalline solid (14.6 g) which was ground to a powder and dried at room temperature in vacuo over MgSO₄ to yield 9.62 g of white solid.

### Example 2

### Dye Removal and Subsequent Dissolution of Post-Consumer Coloured poly(ethylene terephthalet) (PET) Textile in 1,3-dimethyl-2-imidazolidinone (DMI)

1,3-Dimethyl-2-imidazolidinone (DMI, >98%, FChemicals, 10 L) was placed in a 30 L glass jacketed reactor with overhead stirrer and condenser and heated to 100° C. with stirring. Mixed post-consumer 100% PET textile from shredded garments (500 g, mixture of white, red, purple, pink, blue, green and black) was added to the solvent and the mixture was stirred for 30 minutes at 100° C. Leaching of the dyestuffs into the solvent began immediately and was practically complete after 10 minutes. The textile was visibly swollen by the solvent but did not significantly dissolve, whilst the solvent became opaque and dark purple-black in colour. The hot solvent was then pumped off from the vessel, leaving the remaining textile as an off-white solid. Fresh solvent (10 L) was added to the vessel containing the polymer and heated to 160° C. with stirring for 1 hour, over which period the PET dissolved to give a pale yellow solution. This solution was hot-filtered and decanted into a 20 L Pyrex beaker, where it was allowed to return to room temperature. It was then washed with cold DMI (5 L) and subsequently with absolute ethanol (20 L) to remove residual solvent.

1. A process for extracting polyester from fabric and/or packaging containing one or more dyes comprising the steps of:
a) contacting the fabric and/or packaging with a first solvent system to form a mixture;
b) maintaining the mixture at a first temperature for a first period of time until substantially all of the dye has been dissolved;
c) removing the first solvent system containing the dissolved dye;
d) contacting the remaining mixture with a second solvent system in order to dissolve the polyester;
e) maintaining the remaining mixture at the second temperature for a second period of time until substantially all of the polyester has been dissolved;
f) removing the second solvent system containing the dissolved polyester; and
g) recovering the polyester from the second solvent system;
wherein the second temperature is greater than the first temperature when the first solvent system and the second solvent system are the same, and
wherein the second dolvant system comprises a cylic amide.

2.-145. (canceled)

146. The process according to claim 1, wherein the first and second solvent systems are the same.

147. The process according to claim 146, wherein the cyclic amide is selected from compounds according to general Formula I 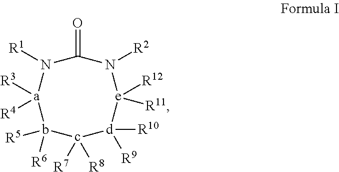
wherein R¹ and R² are each independently selected from: hydrogen, alkyl, alkenyl, alkynyl, aryl or alkoxy groups; R³ to R¹² are each independently selected from: hydrogen, alkyl, alkenyl, alkynyl, aryl or alkoxy groups; wherein each of a to e, if present, is a carbon atom, wherein the total linear chain length of a to e is in the range 2 to 5 carbons.

148. The process according to claim 1, wherein the cyclic amide comprises: N-methyl-2-pyrrolidinone; N-ethyl-2-pyrrolidinone; N-acetyl-2-pyrrolidinone; delta-valerolactam; epsilon-caprolactam; N-methyl-epsilon-caprolactam; N-acetyl-epsilon-caprolactam; N-phenyl-2-pyrrolidinone; N-benzyl-2-pyrrolidinone; 1,3-dimethyltetrahydro-2-pyrimidone; 1,3-diethyltetrahydro-2-pyrimidone; 1,3-dimethyl-2-imidazolidinone; 1,3-diethyl-2-imidazolidinone; or combinations thereof.

149. The process according to claim 148, wherein the cyclic amide comprises 1,3-dimethyl-2-imidazolidinone.

150. The process according to claim 1, wherein the first solvent system and the second solvent system are different.

151. The process according to claim 150, wherein the first solvent system comprises one or more solvents selected from: ketones, haloalkanes, haloalkenes, arenes, substituted cycloalkanes, esters, carbonates or combinations thereof.

152. The process according to claim 150, wherein the cyclic amide is selected from compounds according to general Formula I 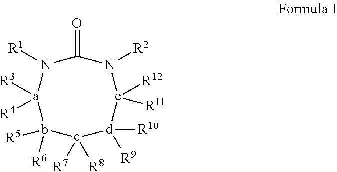
wherein R¹ and R² are each independently selected from: hydrogen, alkyl, alkenyl, alkynyl, aryl or alkoxy groups; R³ to R¹² are each independently selected from: hydrogen, alkyl, alkenyl, alkynyl, aryl or alkoxy groups; wherein each of a to e, if present, is a carbon atom, wherein the total linear chain length of a to e is in the range 2 to 5 carbons.

153. The process according to claim 150, wherein the cyclic amide comprises: N-methyl-2-pyrrolidinone; N-ethyl-2-pyrrolidinone; N-acetyl-2-pyrrolidinone; delta-valerolactam; epsilon-caprolactam; N-methyl-epsilon-caprolactam; N-acetyl-epsilon-caprolactam; N-phenyl-2-pyrrolidinone; N-benzyl -2-pyrrolidinone; 1,3-dimethyltetrahydro-2-pyrimidone; 1,3-diethyltetrahydro-2-pyrimidone; 1,3-dimethyl-2-imidazolidinone; 1,3-diethyl-2-imidazolidinone; or combinations thereof.

154. The process according to claim 153, wherein the cyclic amide comprises 1,3-dimethyl-2-imidazolidinone.

155. The process according to claim 1, wherein the polyester is selected from the group consisting of: Polyglycolic acid (PGA), Polylactic acid (PLA), Polycaprolactone (PCL), Polyethylene adipate (PEA), Polyhydroxyalkanoate (PHA), Polyethylene terephthalate (PET), Polybutylene terephthalate (PBT), Polytrimethylene terephthalate (PTT), Polyethylene naphthalate (PEN) and combination thereof.

156. The process according to claim 155, wherein the polyester is polyethylene terephthalate.

157. The process according to claim 1, wherein the second temperature is greater than the first temperature.

158. The process according to claim 1, further comprising the step of recovering the dye from the first solvent system.

159. The process according to claim 1, further comprising repeating steps a) through g).

160. The process according to claim 159, wherein the first solvent system is reused as the first solvent system in step a) and/or wherein the first solvent system is reused as the second solvent system in step d).

161. The process according to claim 160, wherein the first solvent system is reused as the first solvent system in step a).

162. The process according to claim 159, wherein the second solvent system is reused as the first solvent system in step a) and/or wherein the second solvent system is reused as the second solvent system in step d).

163. The process according to claim 162, wherein the second solvent system is reused as the second solvent system in step d).

164. The process according to claim 1, wherein the first and/or second solvent systems are homogeneous.

165. The process according to claim 1, wherein the first period of time is in the range of 5 minutes to 120 minutes.

166. The process according to claim 165, wherein the first period of time is in the range of 5 minutes to 20 minutes.

167. The process according to claim 1, further comprising a filtration step to remove undissolved impurities from the second solvent system comprising the dissolved polyester.
